(19) United States
(12) Patent Application Publication
(10) Pub. No.: US 2011/0273761 A1
(43) Pub. Date: Nov. 10, 2011

(54) DC-DC CONVERTER, ELECTROPHORETIC DISPLAY DEVICE, AND ELECTRONIC APPARATUS

(75) Inventor: Kiichi Kajino, Hara-mura (JP)

(73) Assignee: Seiko Epson Corporation, Tokyo (JP)

(21) Appl. No.: 13/092,277

(22) Filed: Apr. 22, 2011

(30) Foreign Application Priority Data
May 7, 2010 (JP) 2010-107006

(51) Int. Cl. G02F 1/167; G05F 1/46

(52) U.S. Cl. 359/296; 323/234

(57) ABSTRACT

A DC-DC converter includes a body circuit that performs a first operation of outputting an input voltage inputted from one end to another end based on a control signal, and a second operation of boosting the input voltage and outputting the input voltage boosted through the other end; and a control circuit that outputs the control signal to the body circuit, based on an external load connected to the other end of the body circuit.

### BACKGROUND

1. Technical Field

The present invention relates to DC-DC converters that boost an input voltage and output the same, electrophoretic display devices using the DC-DC converters, and electronic apparatuses.

2. Related Art

As a DC-DC converter of the type mentioned above, a DC-DC converter equipped with a smoothing circuit for smoothing outputs of its body circuit is known. The smoothing circuit has a voltage control switch that connects or disconnects between the body circuit connected to one end of the switch and a capacitor connected to the other end. For example, such a DC-DC converter is described in JP-A-2009-232576. By composing the circuit for smoothing the output voltage with a simple circuit, the DC-DC converter can reduce its power consumption, and its size reduction can be achieved.

Generally, a load that consumes electric energy is connected to the output terminal of the DC-DC converter, which presents a problem in that the output voltage of the DC-DC converter is lowered in voltage by the load.

To solve the problem, various methods have been used in related art, such as, increasing the frequency of a control signal for switching between charging and discharging of the DC-DC converter, increasing the size of transistors used for the switch for switching operation, increasing the capacitance of the capacitor, and the like. However, the increase in the frequency of control signal causes a disadvantage in that the power consumption increases. Further, the increase in the size of the transistors used in the switch or the increase in the capacitance of the capacitor causes a disadvantage in that the size of the circuit becomes larger.

### SUMMARY

In accordance with an advantage of some aspects of the invention, DC-DC converters, electrophoretic display devices, and electronic apparatuses, which can reduce such voltage drop caused by loads, can be provided.

In accordance with an embodiment of the invention, a DC-DC converter includes a body circuit that performs a first operation of outputting an input voltage inputted from one end to another end based on a control signal, and a second operation of boosting the input voltage and outputting the same through the other end, and a control circuit that outputs the control signal to the body circuit, based on an external load connected to the other end of the body circuit.

According to the composition described above, the control circuit outputs a control signal to the body circuit, based on an external load that is connected to the other end of the body circuit. Here, in the second operation, the body circuit boosts and outputs the input voltage. By this operation, the inclination of voltage drop (voltage drop per unit time) of the output voltage due to external load becomes gentler (smaller), compared to the first operation. Accordingly, as the control circuit outputs, based on external load, the control signal for controlling the first operation and the second operation at the body circuit, the duration (duration of time) in which the second operation is performed can be made longer, compared to the duration (duration of time) in which the first operation is performed. Accordingly, voltage drops due to loads can be reduced. Further, compared to a DC-DC converter of related art in which the frequency of control signal is increased, the size of transistors for switching is increased, or the capacitance of capacitors is increased, the DC-DC converter in accordance with the invention controls the ratio between the period of the first operation and the period of the second operation, such that disadvantages such as increases in the power consumption and in the circuit size would not occur. Accordingly, small-sized DC-DC converters that can reduce power consumption can be realized.

Preferably, the control signal described above may be a pulse signal, and the control circuit may set the duty ratio of the pulse signal.

According to the composition described above, the control circuit sets the duty ratio of the pulse signal in the control signal. Accordingly, the control circuit can change the duration of time in which the body circuit performs the first operation and the duration of time in which the body circuit performs the second operation. As a result, voltage drops that may be caused by loads can be readily reduced.

In accordance with an aspect of the embodiment, the body circuit may be equipped with unit circuits each having a capacitor and connected in series between one end and another end of the body circuit. The unit circuit connects the capacitors in parallel with respect to an input voltage in the first operation, and connects the capacitors in series with respect to an input voltage in the second operation.

According to the composition described above, the unit circuits connect the capacitors in parallel with an input voltage in the first operation, and connect the capacitors in series with an input voltage in the second operation. By this, in the body circuit, the capacitors receive an applied input voltage, and store charge in the first operation. Further, for example, when the body circuit is equipped with N (N is an integer of one or greater) unit circuits, each of the capacitors is sufficiently charged in the first operation, and then, the input voltage is boosted to a level that is (N+1) times the input voltage in the second operation and outputted. Therefore, a DC-DC converter that is capable of boosting an input voltage (N+1) times and outputting the boosted voltage can be readily composed.

Preferably, the control circuit may set the duty ratio based on the duration of time in which the charge stored in each of the capacitors reaches a predetermined amount.

According to such a composition, the control circuit sets the duty ratio of the pulse signal in the control signal, based on the duration of time in which the charge stored in the capacitor of each of the unit circuits reaches a predetermined amount. In the first operation, the voltage in each of the capacitors elevates with the input voltage being applied thereto as an asymptote. Therefore, for example, based on the duration of time in which the charge stored in each of the capacitors reaches 95% of the capacitance, the control circuit may set the duty ratio of the pulse signal in the control signal, whereby the input voltage, in other words, the electric energy supplied can be effectively distributed. Accordingly, voltage drops that may be caused by loads can be reduced without increasing the power consumption.

An electrophoretic display device in accordance with an embodiment of the invention is equipped with the DC-DC converter described above.

According to the composition described above, the electrophoretic display device is equipped with the DC-DC converter in accordance with the embodiment described above. As a result, the power consumption by the device can be reduced and, for example, the power duration of a battery used for the device can be extended.

An electronic apparatus in accordance with an embodiment of the invention is equipped with the electrophoretic display device described above.

According to the composition described above, the electronic apparatus is equipped with the electrophoretic display device in accordance with the embodiment described above. As a result, the power consumption by the electronic apparatus can be reduced and, for example, various kinds of electronic apparatuses that require less battery replacement can be realized.

### BRIEF DESCRIPTION OF THE DRAWINGS

FIG. 1 is a block diagram showing the overall structure of a DC-DC converter in accordance with the invention.

FIG. 2 is a circuit diagram for describing an operation of a body circuit shown in FIG. 1.

FIG. 3 is a circuit diagram for describing an operation of the body circuit shown in FIG. 2.

FIG. 4 is a circuit diagram for describing an operation of the body circuit shown in FIG. 2.

FIG. 5 is a schematic diagram showing an example of the structure of a control circuit sown in FIG. 1.

FIG. 6 is a timing chart for describing the relation between clock signals and control signals shown in FIG. 5.

FIG. 7 is a schematic diagram showing another example of the structure of the control circuit sown in FIG. 1.

FIG. 8 is a timing chart for describing the relation between clock signals and control signals shown in FIG. 7.

FIG. 9 is a timing chart for describing an output voltage of a DC-DC converter of related art.

FIG. 10 is a timing chart for describing an output voltage of a DC-DC converter in accordance with an embodiment of the invention.

FIG. 11 is a graph showing the relation between the duty ratios of a pulse signal in a control signal and output voltages.

FIG. 12 is a schematic diagram showing an example of the structure of an electrophoretic display device in accordance with an embodiment of the invention.

FIG. 13 is a block diagram for describing the structure of a power supply circuit shown in FIG. 12.

FIG. 14 is a circuit diagram for describing the structure of a pixel circuit shown in FIG. 12.

FIG. 15 is a cross-sectional view in part of a display section shown in FIG. 12.

FIG. 16 is a schematic cross-sectional view of a microcapsule shown in FIG. 15.

FIGS. 17A and 17B are schematic diagrams for describing an operation of the microcapsule shown in FIG. 15 and FIG. 16.

FIGS. 18A and 18B are views for describing a wristwatch equipped with an electrophoretic display device in accordance with an embodiment of the invention.

FIG. 19 is a perspective view of an electronic paper equipped with an electrophoretic display device in accordance with an embodiment of the invention.

FIG. 20 is a perspective view of an electronic notebook equipped with an electrophoretic display device in accordance with an embodiment of the invention.

### DESCRIPTION OF EXEMPLARY EMBODIMENTS

Preferred embodiments of the invention are described below with reference to the accompanying drawings. In the following description of the drawings, identical or similar components are appended with identical or similar reference numbers, respectively. However, it is noted that the drawings are schematic, and therefore specific measurements of the components should be judged with reference to the description to be made below. Also, the drawings may include corresponding components that are mutually different in their measurement relation and ratio. It is noted that, in the following description, the upper side of each of the drawings will be referred to as “up,” the lower side “down,” the left side “left” and the right side “right.”

DC-DC Converter

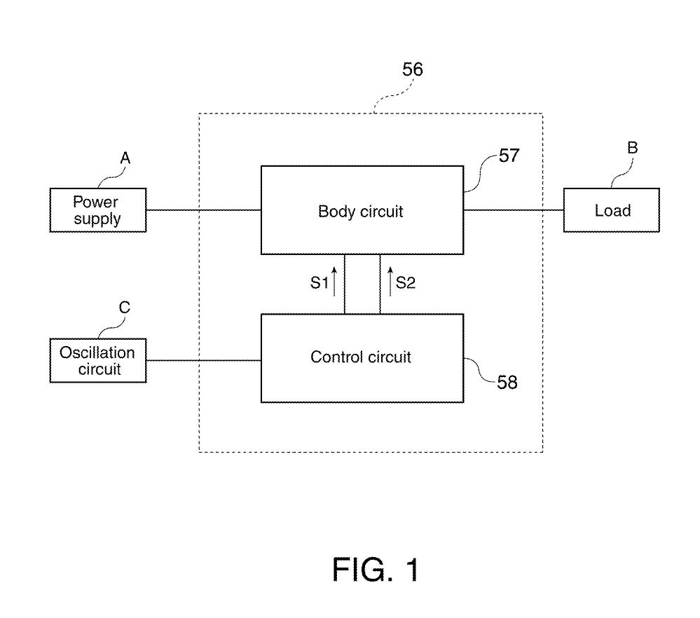

First, referring to FIGS. 1 through 11, a DC-DC converter in accordance with an embodiment of the invention will be described. FIG. 1 is a block diagram for describing the overall structure of a DC-DC converter in accordance with an embodiment of the invention.

As shown in FIG. 1, a DC-DC converter 56 is equipped with a body circuit 57 and a control circuit 58. The body circuit 57 and the control circuit 58 are connected to each other. The control circuit 58 outputs control signals S1 and S2 indicated by arrows in FIG. 1 to the body circuit 57. A power supply A is connected to one end (the left end in FIG. 1) of the body circuit 57, and a load B is connected to the other end (the right end in FIG. 1) of the body circuit 57. Also, an oscillation circuit C is connected to one end (the left end in FIG. 1) of the control circuit 58.

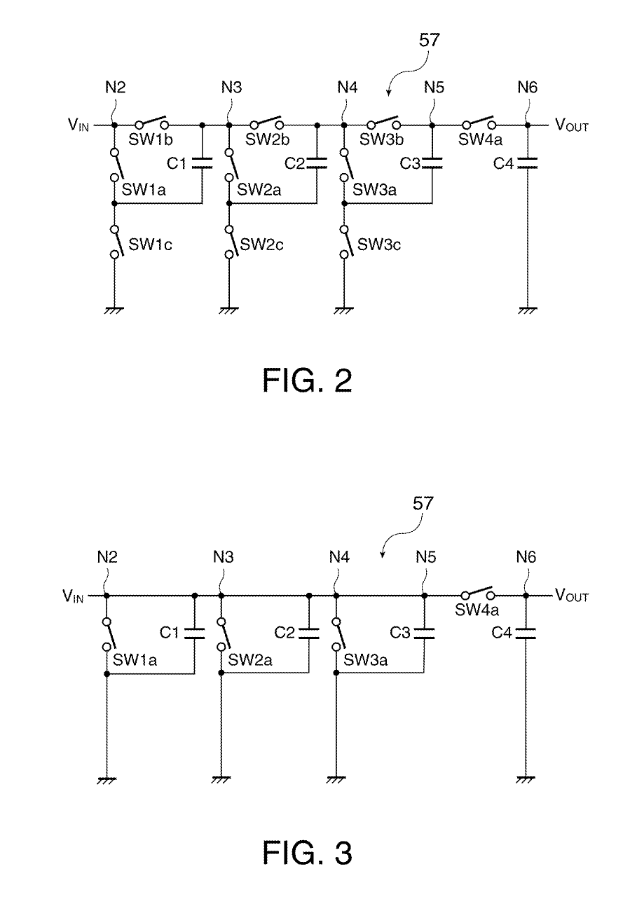

FIG. 2 is a circuit diagram for describing the structure of the body circuit shown in FIG. 1. As shown in FIG. 2, the body circuit 57 is equipped with a unit circuit between connection terminals N2 and N3, a unit circuit between connection terminals N3 and N4, a unit circuit between connection terminals N4 and N5, a switch SW4a, and a capacitor C4. An input voltage V_{IN} is inputted from the power supply A shown in FIG. 1 in the connection terminal (one end of the body circuit 57) N2, and an output voltage V_{OUT} is outputted to the load B shown in FIG. 1 from the connection terminal (the other end of the body circuit 57) N6.

The unit circuit between the connection terminals N2 and N3 has three switches, SW1a, SW1b and SW1c, and one capacitor C1. The switch SW1a and the switch SW1c are mutually connected in series at one ends thereof, respectively. The other end of the switch SW1a is connected to the connection terminal N2, and the other end of the switch SW1c is connected to the ground. The switch SW1b is connected between the connection terminal N2 and the connection terminal N3. The capacitor C1 is connected between a connection point of the switches SW1a and SW1c and the connection terminal N3.

The unit circuit between the connection terminals N3 and N4 has three switches, SW2a, SW2b and SW2c, and one capacitor C2. The switch SW2a and the switch SW2c are mutually connected in series at one ends thereof, respectively. The other end of the switch SW2a is connected to the connection terminal N3, and the other end of the switch SW2c is connected to the ground. The switch SW2b is connected between the connection terminal N3 and the connection terminal N4. The capacitor C2 is connected between a connection point of the switches SW2a and SW2c and the connection terminal N4.

The unit circuit between the connection terminals N4 and N5 has three switches, SW3a, SW3b and SW3c, and one capacitor C3. The switch SW3a and the switch SW3c are mutually connected in series at one ends thereof, respectively. The other end of the switch SW3a is connected to the connection terminal N4, and the other end of the switch SW3c is connected to the ground. The switch SW3b is connected between the connection terminal N4 and the connection terminal N5. The capacitor C3 is connected between a connection point between the switches SW3a and SW3c and the connection terminal N5.

The switch SW4a is connected in series between the connection terminal N5 and the connection terminal N6. The capacitor C4 serves to smooth the output from the three unit circuits described above, and one end of the capacitor C4 is connected to the connection terminal N6 and the other end thereof is connected to the ground.

In the present embodiment, the body circuit 57 is equipped with the capacitor C4. However, the embodiment is not limited to such a structure, and the capacitor C4 may be omitted. In the case, the switch SW4a may also be omitted, and the connection terminal N5 serves as an example of the other end of the body circuit 57.

In the body circuit 57 shown in FIG. 2, a switch group composed of the switches SW1a, SW2a, SW3a and SW4a (hereafter referred to as a first switch group), and a switch group composed of the switches SW1b, SW1c, SW2b, SW2c, SW3b and SW3c (hereafter referred to as a second switch group) are mutually turned on and off, based on the control signals S1 and S2 supplied from the control circuit 58. The control signal S1 shown in FIG. 1 is a signal that controls the first switch group, and the control signal S2 shown in FIG. 1 is a signal that controls the second switch group.

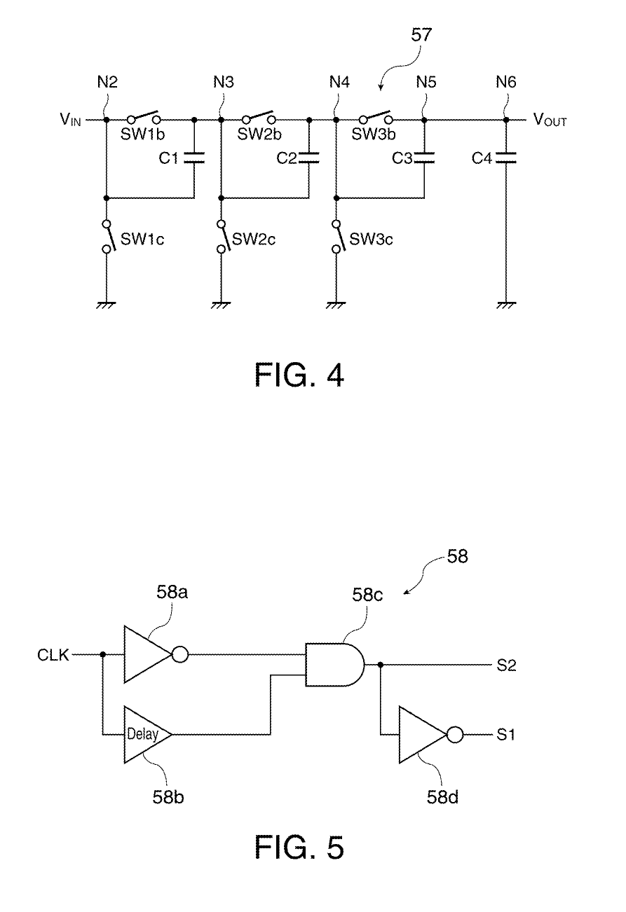

FIG. 3 and FIG. 4 are circuit diagrams for describing an operation of the body circuit shown in FIG. 2. As shown in FIG. 3, when the first switch group in FIG. 2 is turned off, and the second switch group is turned on, the capacitors C1, C2 and C3 of the respective unit circuits are connected in parallel with the input voltage V_{IN}. At this moment, if sufficient charge is stored in the capacitor C4, the voltage on the connection terminal N5 of the body circuit 57 becomes equal to the input voltage V_{IN}. As shown in FIG. 4, when the first switch group in FIG. 2 is turned on, and the second switch group is turned off, the capacitors C1, C2 and C3 of the respective unit circuits are connected in series between the connection terminal N2 and the connection terminal N5 with respect to the input voltage V_{IN}. By this operation, the output voltage V_{OUT} of the body circuit 57 is boosted (elevated) to a level that is four times the input voltage V_{IN} (hereafter expressed as the input voltage V_{IN}×4). In this manner, the body circuit 57 repeats the operation shown in FIG. 3 (hereafter referred to as the first operation) and the operation shown in FIG. 4 (hereafter referred to as the second operation), based on the control signals S1 and S2, while mutually switching the operations.

In the present embodiment, the body circuit 57 is structured to have three unit circuits. However, without any particular limitation, the body circuit 57 may be structured to have four or more unit circuits. Also, the input voltage may be outputted after being boosted to an arbitrary output voltage V_{OUT} (=(N+1)×V_{IN}; N is an integer of 1 or greater) by suitably changing the composition of the body circuit 57.

In this manner, according to the body circuit 57, each of the capacitors C1, C2 and C3 receives the applied input voltage V_{IN} in the first operation shown in FIG. 3, and stores charge. Also, for example, when the body circuit 57 is equipped with N (N is an integer of 1 or greater) unit circuits, each of the capacitors C1, C2 and C3 is sufficiently charged in the first operation, and then, an output voltage that is boosted to a level being (N+1) times the input voltage V_{IN} in the second operation shown in FIG. 4 can be outputted.

FIG. 5 is a schematic structural diagram for describing the structure of the control circuit shown in FIG. 1. As shown in FIG. 5, the control circuit 58 is equipped with an inverter circuit 58a, a delay circuit 58b, a logical product (AND) circuit 58c, and an inverter circuit 58d. The control circuit 58 receives a clock signal CLK as an input from the oscillation circuit C shown in FIG. 1 that is connected to one end thereof (the left end in FIG. 5), and outputs control signals S1 and S2 to the body circuit 57 shown in FIG. 2 that is connected to the other end thereof (the right end in FIG. 5).

Input lines of the inverter circuit 58a and the delay circuit 58b are connected in parallel to the one end of the control circuit 58. Output lines of the inverter circuit 58a and the delay circuit 58b are connected to input lines of the AND circuit 58c. An output line of the AND circuit 58c outputs a control signal S2 and is connected to an input line of the inverter 58d. An output line of the inverter circuit 58d outputs a control signal S1.

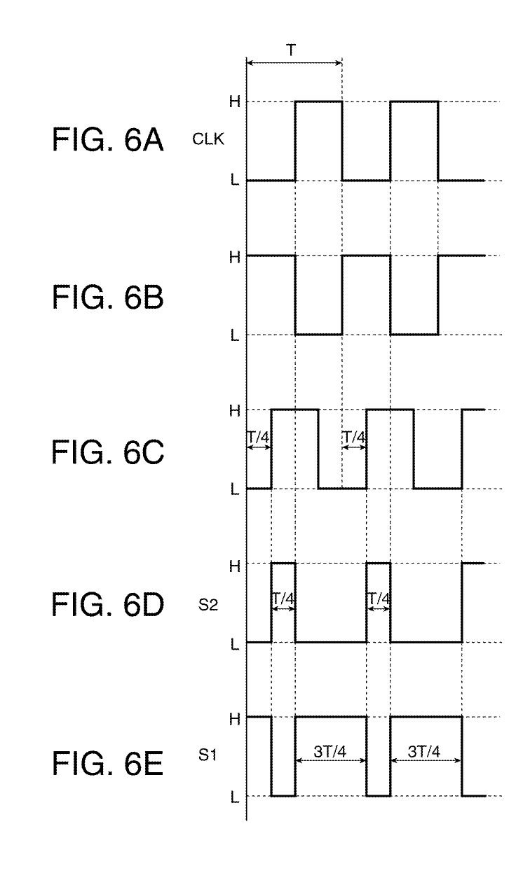

FIGS. 6A-6E are timing charts for describing the relation between the clock signal and the control signals described with reference to FIG. 5. As shown in FIG. 6A, the clock CLK that is inputted in the inverter circuit 58a and the delay circuit 58b is a pulse signal that repeats high level H and low level L with a period T, whose duty ratio is set at 50% (0.5), for example.

The inverter circuit 58a outputs an inverted signal of the inputted clock signal CLK, in other words, a signal that becomes high level H when the clock signal CLK becomes low level L, and becomes low level L when the clock signal CLK becomes high level H, as shown in FIG. 6B. The delay circuit 58b delays the inputted clock signal CLK by a predetermined duration of time and outputs a delay signal, in other words, a signal whose phase is delayed by 0.25T (T/4), as shown in FIG. 6c, for example.

The AND circuit 58c outputs a signal that is a logical product of the signal inputted from the inverter circuit 58a shown in FIG. 6B and the signal inputted from the delay circuit 58b shown in FIG. 6C, in other words, a pulse signal with the pulse width being 0.25T (T/4) as the control signal S2, as shown in FIG. 6D. By this, the duty ratio of the control signal S2 is set at 25% (0.25). The inverter circuit 58d outputs an inverted signal of the control signal S2 shown in FIG. 6D, in other words, a pulse signal with the period being T and the pulse width being 0.75T (T×3/4) as the control signal S1 as shown in FIG. 6E. By this, the duty ratio of the control signal S1 is set at 75% (0.75).

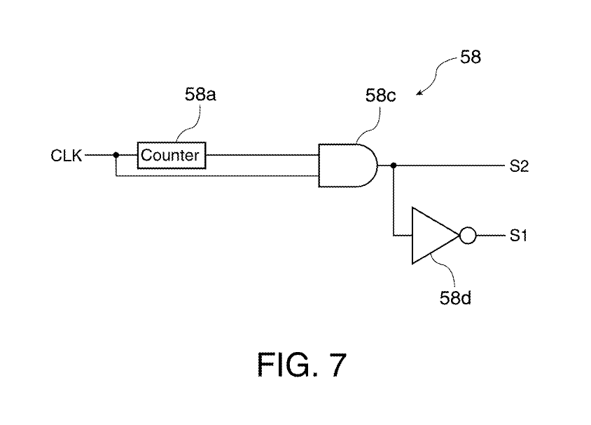

FIG. 7 is a schematic structural diagram for describing another example of the structure of the control circuit shown in FIG. 1. The control circuit 58 may have another structure, without any particular limitation to the structure shown in FIG. 5. For example, as shown in FIG. 7, the control circuit 58 may be equipped with a counter circuit 58e, instead of the inverter circuit 58a and the delay circuit 58b shown in FIG. 5. The control circuit 58, like the structure shown in FIG. 5, receives a clock signal CLK as an input at one end thereof (the left end in FIG. 7), and outputs control signals S1 and S2 from the other end (the right end in FIG. 7).

An input line of the counter circuit 58e and one of input lines of the AND circuit 58c are connected in parallel to the one end of the control circuit 58. An output line of the counter circuit 58e is connected to the other input line of the AND circuit 58c. An output line of the AND circuit 58c outputs a control signal S2, and is connected to an input line of the inverter circuit 58d. An output line of the inverter circuit 58d outputs a control signal S1.

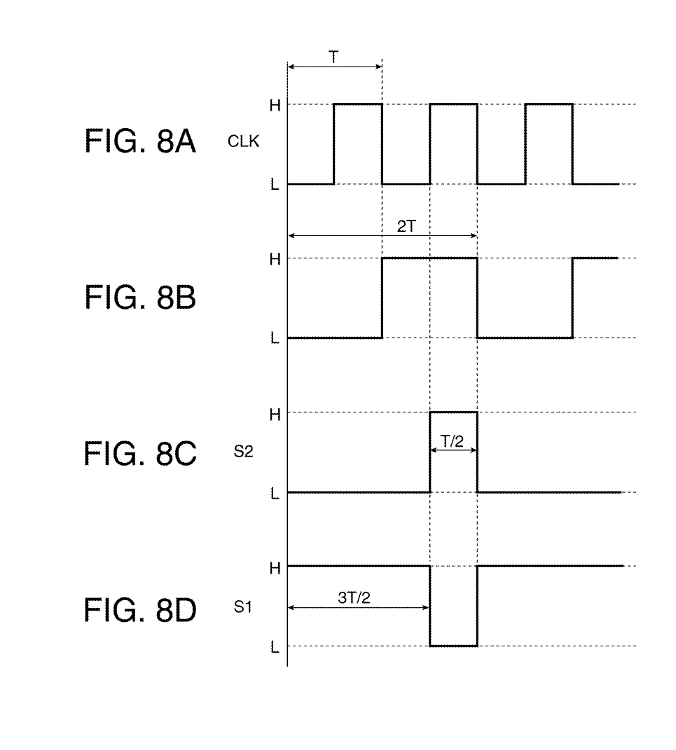

FIGS. 8A-8D are timing charts for describing the relation between the clock signal and the control signals described with reference to FIG. 7. As shown in FIG. 8A, the clock CLK that is inputted in the counter circuit 58a and the AND circuit 58c is a pulse signal that repeats high level H and low level L with a period T, whose duty ratio is set at 50% (0.5), for example.

The counter circuit 58e is, for example, a one-bit (stage) binary counter, and outputs a signal having a period that is two times the period T of the inputted clock signal CLK, in other words, a pulse signal with a period being 2T (T×2), as shown in FIG. 8B.

The AND circuit 58c outputs a signal that is a logical product of the clock signal CLK shown in FIG. 8A and the signal inputted from the counter circuit 58e shown in FIG. 8B, in other words, a pulse signal with the period being 2T (T×2) and the pulse width being 0.5T (T/2) as the control signal S2, as shown in FIG. 8C. By this, the duty ratio of the control signal S2 is set at 25% (0.25). The inverter circuit 58d outputs an inverted signal of the control signal S2 shown in FIG. 8C, in other words, a pulse signal with the period being 2T (T×2) and the pulse width being 1.5T (T×3/2) as a control signal S1, as shown in FIG. 8D. By this, the duty ratio of the control signal S1 is set at 75% (0.75).

The first switch group of the body circuit 57 shown in FIG. 2 turns on when the control signal S1 is at high level H, and turns off when the control signal S1 is at low level L. Similarly, the second switch group of the body circuit 57 shown in FIG. 2 turns on when the control signal S2 is at high level H, and turns off when the control signal S2 is at low level L.

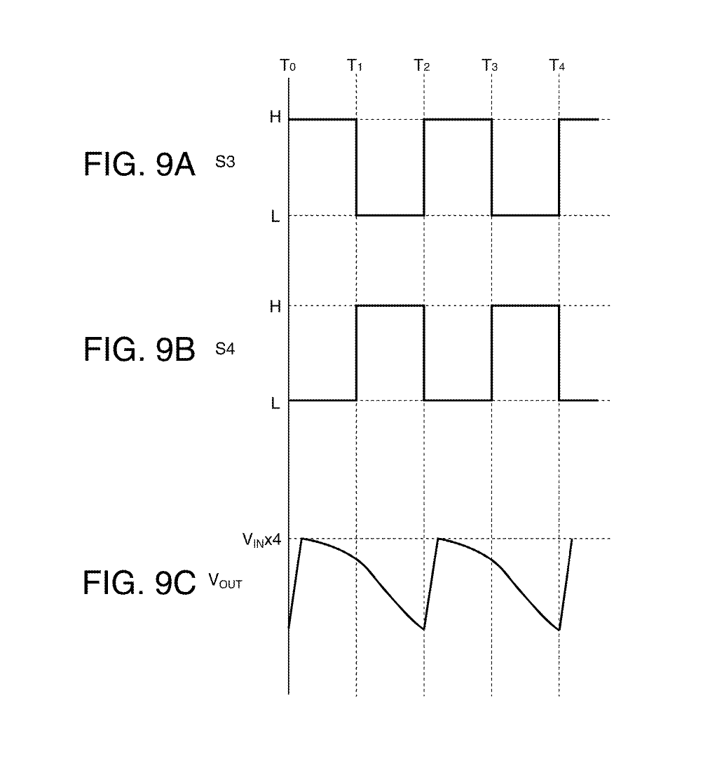

FIGS. 9A-9C are timing charts for describing output voltages of a DC-DC converter of related art. The DC-DC converter of related art, which is equipped with a body circuit similar to the body circuit 57 shown in FIG. 2, uses a control signal S3 for controlling the first switch group which is a pulse signal with the duty ratio being 50% (0.5), as shown in FIG. 9A, and a control signal S4 for controlling the second switch group which is an inverted signal of the control signal S3, in other words, a pulse signal with the duty ratio being 50% (0.5), as shown in FIG. 9B.

As shown in FIG. 9C, the output voltage Vₒᵤₜ outputted from the body circuit elevates to a level that is four times the input voltage Vᵢₙ (Vᵢₙ×4) during the period T₀-T₁ and the period T₂-T₃. This voltage elevation occurs because the capacitors are connected in series as a result of the first switch group being turned on and the second switch group being turned off, like the case shown in FIG. 4. After the voltage has elevated to a level four times the input voltage Vᵢₙ, the output voltage Vₒᵤₜ gently lowers. In this case, the voltage lowers as the power is consumed by the load connected to the output end of the body circuit. Then, the output voltage Vₒᵤₜ rapidly lowers during the period T₁-T₂ and the period T₃-T₄. This is because the capacitors are connected in parallel as a result of the first switch group being turned off and the second switch group being turned on, and only the capacitor for smoothing (C4 in FIG. 3) is placed in a state of being connected to the external load, like the case shown in FIG. 3. As the current is supplied to the load by the charge stored in the capacitor for smoothing, the charge rapidly reduces, such that the voltage drop in the output voltage Vₒᵤₜ becomes significant.

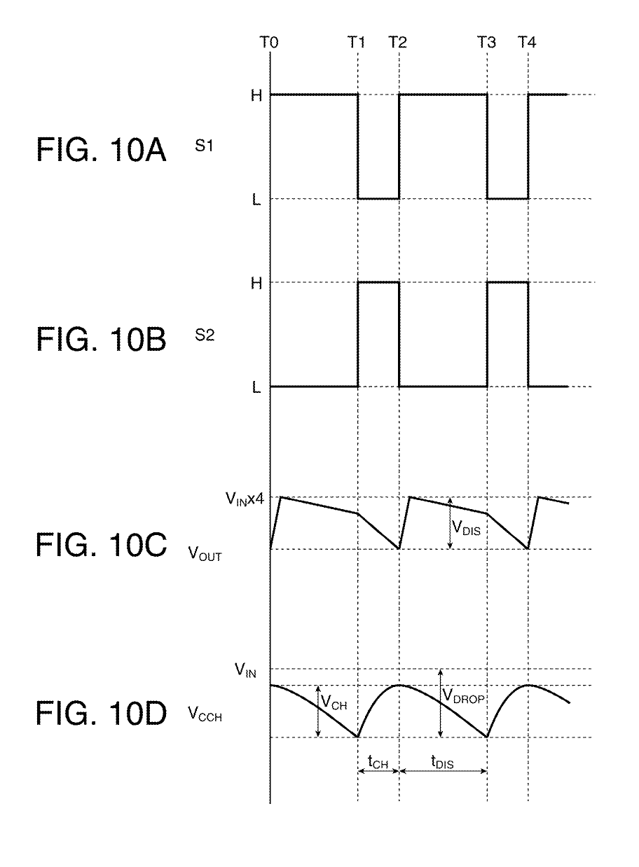

FIGS. 10A-10D are timing charts for describing output voltages of the DC-DC converter in accordance with the present embodiment. The DC-DC converter 56 in accordance with the present embodiment is equipped with the control circuit 58, and the control circuit 58 outputs control signals S1 and S2 to the body circuit 57, based on the external load B shown in FIG. 1. More specifically, as shown in FIGS. 10A and 10B, compared to the DC-DC converter of related art shown in FIG. 9, the control signals S1 and S2 that are longer in the period T₀-T₁ and the period T₂-T₃ and shorter in the period T₁-T₂ and the period T₃-T₄ are outputted. More specifically, for example, the control signal S1 is a pulse signal with the duty ratio being 75% (0.75), and the control signal S2 is a pulse signal with the duty ratio being 25% (0.25).

Here, as shown in FIG. 10A and FIG. 10B, when the control signal S1 is at high level H and the control signal S2 is at low level L as in the period T₀-T₁ and the period T₂-T₃, in other words, in the second operation shown in FIG. 4, the body circuit 57 boosts the input voltage V_{IN} and outputs the same. By this, compared to the case where the control signal S1 is at low level L and the control signal S2 is at high level H as in the period T₁-T₂ and the period T₃-T₄, in other words, in the first operation shown in FIG. 3, the inclination of the voltage drop (the voltage drop per unit time) in the output voltage V_{OUT} caused by the external load B becomes gentler (smaller). Therefore, as the control circuit 58 outputs, based on the external load B, the control signals S1 and S2 that control the first operation and the second operation in the body circuit 57, the period T₀-T₁ and the period T₂-T₃ during which the second operation is performed can be made longer, compared to the period T₁-T₂ and the period T₃-T₄ during which the first operation is performed.

In order to make the period T₀-T₁ and the period T₂-T₃ during which the second operation is performed longer, the predetermined duration of time to be delayed by the delay circuit 58b shown in FIG. 5 is changed to set the duty ratios of the pulse signals in the control signals S1 and S2 as shown in FIGS. 6D and 6E. Also, by changing the bit number (the number of stages) and/or the count value of the counter circuit 58e shown in FIG. 7, the duty ratios of the pulse signals in the control signals S1 and S2 are set as shown in FIGS. 8C and 8D. As a result, the control circuit 58 can change the durations of the period T₁-T₂ and the period T₃-T₄ during which the body circuit 57 performs the first operation, and the durations of the period T₀-T₁ and the period T₂T₃ during which the body circuit 57 performs the second operation.

Also, in the first operation and the second operation of the body circuit 57, the voltage V_{CC} of each of the capacitors C1, C2 and C3 changes as shown in FIG. 10D. Here, as shown in FIG. 10A and FIG. 10B, when the control signal S1 is at low level L and the control signal S2 is at high level H as in the period T₁-T₂ and the period T₃-T₄, in other words, in the first operation shown in FIG. 3, the voltage V_{CCH} of each of the capacitors C1, C2 and C3 elevates with the applied input voltage V_{IN} as an asymptotic line, as shown in FIG. 10D. Therefore, based on the duration of time in which the charge stored in each of the capacitors C1, C2 and C3 reaches 95% of the capacitance thereof, for example, the control circuit 58 sets the duty ratios of the pulse signals in the control signals S1 and S2, whereby the input voltage V_{IN}, in other words, the supplied electric energy can be effectively distributed.

Next, the output voltage provided by the body circuit is described with theoretical formulas.

In the body circuit 57 shown in FIG. 2, let us assume that the capacitance of each of the capacitors C1, C2 and C3 of the unit circuits is C_{CH}, the on-resistance of each of the switches SW1b, SW2b and SW3b is R_{P}, the on-resistance of each of the switches SW1c, SW2c and SW3c is R_{N}, the on-resistance of each of the unit circuits in the first operation is R_{CH} (=R_{P}+P_{N}), the on-resistance of the switch SW4a is R_{OUT}, the capacitance of the capacitor C4 is C_{OUT}, and the number of the unit circuits of the body circuit 57 is generally represented as N. Further, let us assume that the current that flows to the load B is I_{LOAD}, the voltage dropped by the load B is V_{DIS} as shown in FIG. 10C, the duration of time of the first operation is t_{CH} as shown in FIG. 10D, the duration of time of the second operation is t_{DIS} as shown in FIG. 10D, the voltage stored in each of the capacitors C1, C2 and C3 is V_{CH}, and the voltage drop dropped from the input voltage V_{IN} due to the load B is V_{DROP}.

The period T of the pulse signal in each of the control signals S1 and S2 has the relation T=t_{CH}+t_{DIS}, and therefore Formulas (1)-(4) can be established, as follows.

V_{DIS}/N=V_{CH} (1)

V_{CH}=(1−e^{-t}^{_{CH}}^{/R}^{_{CH}}^{C}^{_{CH}})V_{DROP} (2)

V_{CH}C_{CH}=I_{CH}R_{CH} (3)

$${I}_{LOAD} T = {V}_{DIS} \{ \frac{{t}_{CH}}{T} {C}_{OUT} + \frac{{t}_{DIS}}{T} ( {C}_{OUT} + \frac{{C}_{CH}}{N} ) \} \qquad ( 4 )$$

By rearranging Formulas (1)-(4), Formula (5) can be derived for the dropped voltage V_{DROP} lowered from the input voltage V_{IN} due to the load B, as follows.

$${V}_{DROP} = \frac{{I}_{LOAD} {T}^{2}}{( T ( {C}_{OUT} N + {C}_{CH} ) - {t}_{CH} {C}_{CH} ) ( 1 - {e}^{- {t}_{CH} / {R}_{CH} {C}_{CH}} )} \qquad ( 5 )$$

On the other hand, if the duration of time t_{DIS} of the second operation is a sufficient time duration in which both of the ends of the switch SW4a reach the same potential, the output voltage V_{OUT} of the body circuit 57 can be expressed by Formula (6) as follows:

V_{OUT}=(V_{IN}−V_{DROP})N+V_{IN} (6)

By substituting Formula (5) for Formula (6), Formula (7) can be obtained as follows:

$${V}_{OUT} = {V}_{IN} ( N + 1 ) \frac{{I}_{LOAD} {T}^{2}}{( {TC}_{OUT} N + {TC}_{CH} - {t}_{CH} {C}_{CH} ) ( 1 - {e}^{- {t}_{CH} / {R}_{CH} {C}_{CH}} )} N \qquad ( 7 )$$

In this manner, the output voltage V_{OUT} can be represented by a relational expression of the duration of time t_{CH} of the first operation. Therefore, by setting the rate of the duration of time t_{CH} of the first operation in the period T, in other words, the duty ratio of the pulse signal in each of the control signals S1 and S2 such that the output voltage V_{OUT} becomes maximum, the drop voltage V_{DIS} that may drop by the load B can be made minimum.

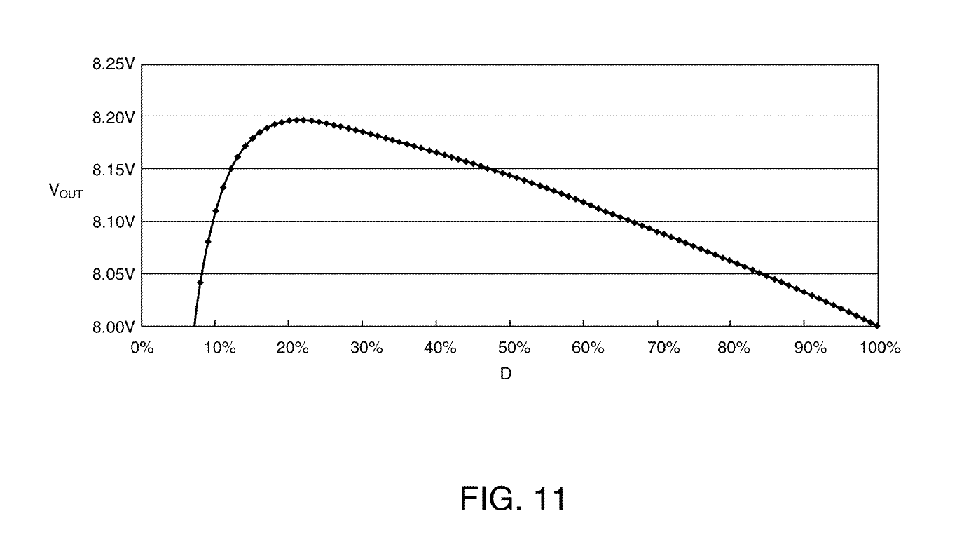

FIG. 11 is a graph showing the relation between the duty ratio of the pulse signal in the control signal and the output voltage. For example, when the input voltage V_{IN} is 3 V (V_{IN}=3 V), the number of the unit circuits N is 3 (N=3), the on-resistance of each of the unit circuits in the first operation R_{CH} is 50Ω (R_{CH}=50Ω), the capacitance of each of the capacitors C1, C2 and C3 C_{CH} is 1 μF (C_{CH}=1 μF), the capacitance of the capacitor C4 C_{OUT} is 1 μF (C_{OUT}=1 μF), the current that flows to the load B I_{LOAD} is 1 mA (I_{LOAD}=1 mA), and the period of the control signals S1 and S2 T is 1 msec (T=1 msec), the output voltage V_{OUT} with respect to the duty ratio D of the control signal S2 can be plotted based on Formula (7) on a graph shown in FIG. 9.

In the example described above, when the duty ratio D of the control signal S2 is 22% (D=22%), the output voltage V_{OUT} becomes 11.1965 V (V_{OUT}=11.1965 V (the significant digits are 6 digits), which is the maximum value.

It is noted that the duty ratio D with which the output voltage V_{OUT} becomes maximum defers depending on the number N of the unit circuits, the on-resistance R_{CH} of each of the unit circuits in the first operation, the capacitance C_{CH} of each of the capacitors C1, C2 and C3, the capacitance C_{OUT} of the capacitor C4, the current I_{LOAD} flowing to the load B, and the period T.

According to the DC-DC converter 56 in accordance with the present embodiment, the control circuit 58 outputs the control signals S1 and S2 to the body circuit 57, based on the external load B that is connected to the other end of the body circuit 57. Here, as shown in FIG. 10A and FIG. 10B, when the control signal S1 is at high level H and the control signal S2 is at low level L as in the period T₀-T₁ and the period T₂-T₃, in other words, in the second operation shown in FIG. 4, the body circuit 57 boosts and outputs the input voltage V_{IN}. By this, compared to the case where the control signal S1 is at low level L and the control signal S2 is at high level H as in the period T₁-T₂ and the period T₃-T₄, in other words, in the first operation shown in FIG. 3, the inclination of the voltage drop (the voltage drop per unit time) in the output voltage V_{OUT} caused by the external load B becomes gentler (smaller). Therefore, as the control circuit 58 outputs, based on the external load B, the control signals S1 and S2 that control the first operation and the second operation in the body circuit 57, the period T₀-T₁ and the period T₂-T₃ during which the second operation is performed can be made longer, compared to the period T₁-T₂ and the period T₃-T_{4 during which the first operation is performed. Accordingly, voltage drop due to the load B can be reduced. Further, compared to a DC-DC converter of related art in which the frequency of control signal is increased, the size of transistors for switching is increased, the capacitance of capacitors is increased or the like, the DC-DC converter in accordance with the invention controls the ratio between the duration of the first operation and the duration of the second operation, such that disadvantages such as increases in the power consumption and in the circuit size would not occur. Accordingly, small-sized DC-DC converters that can reduce power consumption can be realized.}

Furthermore, according to the DC-DC converter 56 in accordance with the present embodiment, the control circuit sets the duty ratio of the pulse singles in the control signals S1 and S2. By this structure, the control circuit 58 can change the durations of the period T₁-T₂ and the period T₃-T₄ during which the body circuit 57 performs the first operation, and the durations of the period T₀-T₁ and the period T₂-T₃ during which the body circuit 57 performs the second operation. As a result, voltage drops by the load B can be readily reduced.

Moreover, according to the DC-DC converter 56 in accordance with the present embodiment, the unit circuits connect the capacitors C1, C2 and C3 in parallel with respect to the input voltage V_{IN} in the first operation, and connect the capacitors C1, C2 and C3 in series with respect to the input voltage V_{IN} in the second operation. By this operation, in the body circuit 57, in the first operation shown in FIG. 3, each of the capacitors C1, C2 and C3 receives the applied input voltage V_{IN} and stores charge. Also, for example, when the body circuit 57 is equipped with N (N is an integer of one or greater) unit circuits, each of the capacitors C1, C2 and C3 is sufficiently charged in the first operation, and then, the input voltage V_{IN} is boosted to a level that is (N+1) times the input voltage V_{IN} in the second operation shown in FIG. 4 and outputted. Therefore, the DC-DC converter that is capable of boosting the input voltage V_{IN} (N+1) times and outputting the boosted voltage can be readily composed.

Also, according to DC-DC converter 56 in accordance with the present embodiment, based on the duration of time in which the charge stored in each of the capacitors C1, C2 and C3 of the unit circuits reaches a predetermined amount, the control circuit 58 sets the duty ratio of the pulse signals in the control signals S1 and S2. Here, as shown in FIG. 10A and FIG. 10B, when the control signal S1 is at low level L and the control signal S2 is at high level H as in the period T₁-T₂ and the period T₃-T₄, in other words, in the first operation shown in FIG. 3, the voltage V_{CCH} of each of the capacitors C1, C2 and C3 elevates with the applied input voltage V_{IN} as an asymptotic line, as shown in FIG. 10D. Therefore, based on the duration of time in which the charge stored in each of the capacitors C1, C2 and C3 reaches 95% of the capacitance thereof, the control circuit 58 sets the duty ratios of the pulse signals in the control signals S1 and S2, whereby the input voltage V_{IN}, in other words, the supplied electric energy can be effectively distributed. By this, voltage drops by the load B can be reduced without increasing power consumption.

Electrophoretic Display Device

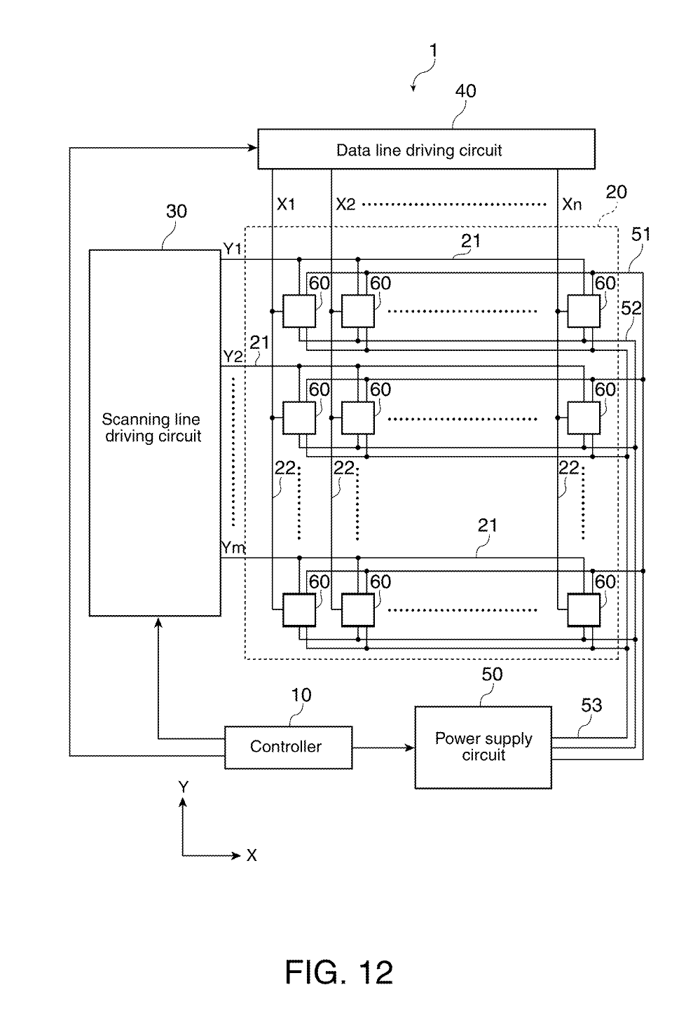

FIGS. 12 through 17 are views for describing an electrophoretic display device in accordance with an embodiment of the invention. FIG. 12 is a schematic structural diagram of an example of an electrophoretic display device in accordance with an embodiment of the invention. As shown in FIG. 12, the electrophoretic display device 1 is equipped with a controller 10, a display section 20, a scanning line driving circuit 30, a data line scanning circuit 40, and a power supply circuit 50.

The controller 10 controls the operations of the scanning line driving circuit 30, the data line scanning circuit 40, and the power supply circuit 50. The controller 10 includes an image signal processing circuit (not shown), which generates various kinds of signals, such as, image signals for an image to be displayed on the display section 20, reset signals for setting at the time of rewriting images, and timing signals including clock signals, start pulses and the like, and output these signals to the scanning line driving circuit 30, the data line driving circuit 40 and the power supply circuit 50.

The display section 20 is equipped with m scanning lines 21 arranged along a Y direction of a generally plane surface (scanning lines Y1, Y2, . . . , Ym), n data lines 22 arranged along an X direction of the generally plane surface (data lines X1, X2, . . . , Xn), and pixel circuits 60 arranged at intersections between the scanning lines 21 and the data lines 22, respectively.

The scanning line driving circuit 30 is connected to each the scanning lines Y1, Y2, . . . , Ym of the display section 20. Also, the scanning line driving circuit 30 sequentially supplies a pulsed scanning line signal to each of the scanning lines Y1, Y2, . . . , Ym, based on a timing signal inputted from the controller 10.

The data line driving circuit 40 is connected to each of the data lines X1, X2, . . . , Xn of the display section 20. The data line driving circuit 40 supplies an image signal to the data lines X1, X2, . . . , Xn, based on a timing signal inputted from the controller 10. The image signal assumes a binary level, i.e., a high potential level (hereafter referred to as “high level”), for example 5V, or a low potential level (hereafter referred to as “low level”), for example, 0V.

The power supply circuit 50 is connected to a high-potential power supply line 51, a low-potential power supply line 52, and a common potential line 53. Further, the power supply circuit 50 supplies a predetermined high-potential VH, for example, 12-15 volt to the high-potential power supply line 51, a predetermined low-potential VL, for example, 0 volt to the low-potential power supply line 52, and a common potential Vcom to the common potential line 53.

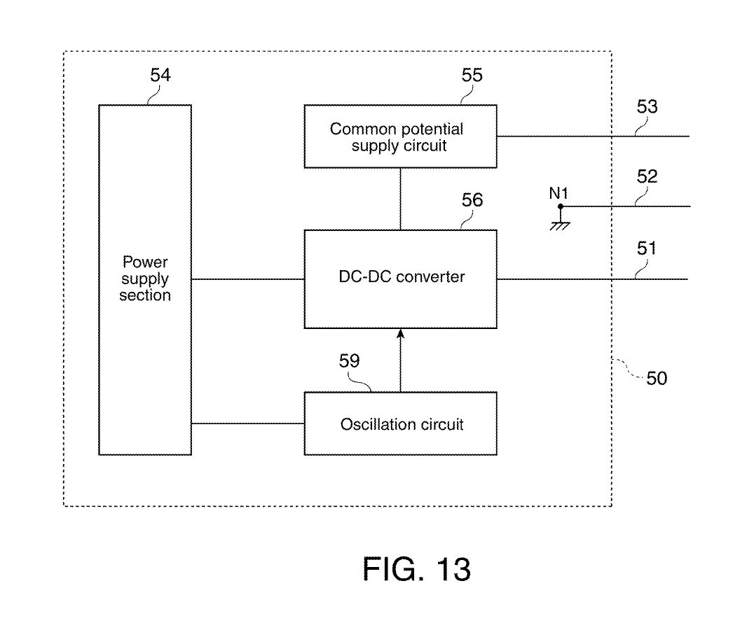

FIG. 13 is a block diagram for describing the structure of the power supply circuit 50 shown in FIG. 12. The power supply circuit 50 is equipped with a power supply section 54, a common potential supply circuit 55, a DC-DC converter 56 in accordance with the embodiment of the invention described above, and an oscillation circuit 59.

The power supply section 54 is connected to and supplies power to each of the common-potential supply circuit 55, the DC-DC converter 56 and the oscillation circuit 59. The power supply section 54 may use a primary battery or a secondary battery, which may be provided inside the electrophoretic display device 1, and supplies the power supply voltage Vdc (for example, 3 V). In the present embodiment, the power supply section 54 supplies power only to the common-potential supply circuit 55, the DC-DC converter 56, and the oscillation circuit 59; however, it is not limited thereto and the power supply section 54 may supply power to the other circuits, for example, the controller 10.

The common-potential supply circuit 55 is connected to the common potential line 53 and outputs the common potential Vcom on the basis of the power supply voltage Vdc applied from the power supply section 54.

The DC-DC converter 56 is connected to the high-potential power supply line 51, and outputs the high potential VH on the basis of the power supply voltage Vdc applied from the power supply section 54.

The oscillation circuit 59 is connected to the DC-DC converter 56, and supplies the clock signal to the DC-DC converter 56.

The power supply circuit 50 outputs the low potential VL through its connection terminal N1 connected to the ground to the low-potential power supply line 52.

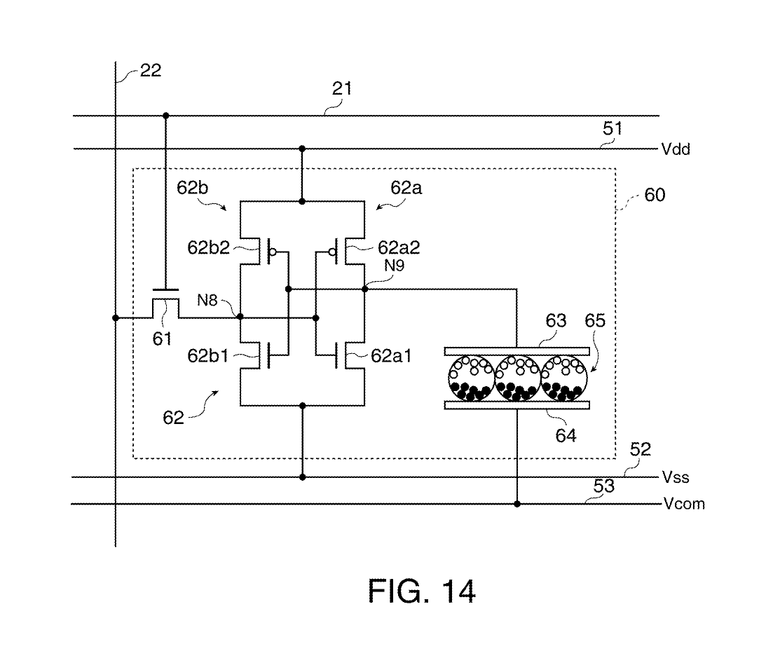

FIG. 14 is a circuit diagram for describing the structure of each of the pixel circuits shown in FIG. 12. As shown in FIG. 14, the pixel circuit 60 is equipped with a switching transistor 61, a memory circuit 62, a pixel electrode 63, a common electrode 64, and an electrophoretic element 65.

The switching transistor 61 is constituted of an N-type transistor, and has a gate connected to the scanning line 21, a source connected to the data line 22, and a drain connected to the input terminal N8 of the memory circuit 62. The switching transistor 61 outputs an image signal supplied from the data-line driving circuit 40 through the data line 22 to the input terminal N8 of the memory circuit 62 at a timing corresponding to a scanning signal supplied from the scanning-line driving circuit 62 through the scanning line 21.

The memory circuit 65 includes inverter circuits 62a and 62b and is configured as a static random access memory (SRAM).

The inverter circuits 62a and 62b have a loop structure in which their individual input terminals are connected to the other output terminals. In other words, the input terminal of the inverter circuit 62a and the output terminal of the inverter circuit 62b are connected to each other, and the input terminal of the inverter circuit 62b and the output terminal of the inverter circuit 62a are connected to each other. The input terminal of the inverter circuit 62a is configured as the input terminal N8 of the memory circuit 62, and the output terminal of the inverter circuit 62a is configured as the output terminal N9 of the memory circuit 62.

The inverter circuit 62a includes an N-type transistor 62a1 and a P-type transistor 62a2. The gates of the N-type transistor 62a1 and the P-type transistor 62a2 are connected to the input terminal N8 of the memory circuit 62. The source of the N-type transistor 62a1 is connected to the low-potential power supply line 52. The source of the P-type transistor 62a2 is connected to the high-potential power supply line 51. The drains of the N-type transistor 62a1 and the P-type transistor 62a2 are connected to the output terminal N9 of the memory circuit 62.

The inverter circuit 62b includes an N-type transistor 62b1 and a P-type transistor 62b2. The gates of the N-type transistor 62b1 and the P-type transistor 62b2 are connected to the output terminal N9 of the memory circuit 62. The source of the N-type transistor 62b1 is connected to the low-potential power supply line 52. The source of the P-type transistor 62b2 is connected to the high-potential power supply line 51. The drains of the N-type transistor 62b1 and the P-type transistor 62b2 are connected to the input terminal N8 of the memory circuit 62.

When a high-level image signal is inputted to the input terminal N8 of the memory circuit 62 thus configured, the memory circuit 62 outputs the low-potential VL from the output terminal N9 thereof, and when a low-level image signal is inputted to the input terminal N8, the memory circuit 62 outputs the high-potential VH from the output terminal N9.

The pixel electrode 63 is connected to the output terminal N8 of the memory circuit 62. In other words, the high-potential VH or the low-potential VL is supplied from the memory circuit 62 to the pixel electrode 63 according to an image signal inputted in the memory circuit 62. Also, the pixel electrode 63 is disposed to face the common electrode 64 through the electrophoretic element 65.

The common electrode 64 is connected to the common potential line 53, to which the common potential Vcom is supplied.

The electrophoretic element 65 is disposed between the pixel electrode 63 and the common electrode 64, and is constituted of a plurality of microcapsules.

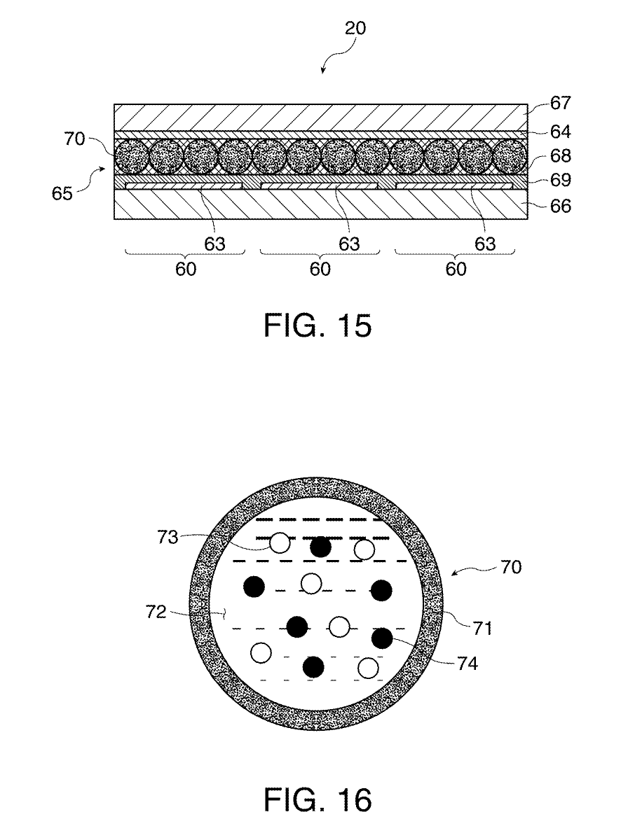

FIG. 15 is a cross-sectional view in part of the display section shown in FIG. 12. As shown in FIG. 15, the display section 20 is constituted in a manner that the electrophoretic element 65 is held between a device substrate 66 and a counter substrate 67.

The device substrate 66 is a substrate made of, for example, glass or resin. Although illustration is omitted in FIG. 15, a laminate structure including the switching transistor 61, the memory circuit 62, the scanning line 21, the data line 22, the high-potential power supply line 51, the low-potential power supply line 52, and the common potential line 53 described above is formed on the device substrate 66. A plurality of pixel electrodes 63 is provided in a matrix configuration on the upper layer side of the laminate structure.

The counter substrate 67 is a light-transmissive substrate formed from glass or plastic, for example. The common electrode 64 is solidly formed on the surface of the counter substrate 67 facing the device substrate 66 so as to face the plurality of pixel electrodes 63. The common electrode 64 is formed from a light-transmissive conducting material, such as, for example, magnesium-silver (MgAg), indium tin oxide (ITO), or indium zinc oxide (IZO).

The electrophoretic element 65 is constituted of a plurality of microcapsules 70 each containing electrophoretic particles and is fixed between the device substrate 66 and the counter substrate 67 with a binder 68 and an adhesive layer 69 made of resin or the like. The electrophoretic display device 1 according to the present embodiment is manufactured such that an electrophoretic sheet, in which the electrophoretic element 65 is fixed in advance to the counter substrate 67 with the binder 68, is bonded to the device substrate 66, which is separately manufactured and on which the pixel electrodes 63, etc. are formed, with the adhesive layer 69.

The microcapsules 70 are sandwiched between the pixel electrode 63 and the common electrode 64, and one or a plurality of microcapsules 70 is disposed in each one of the pixel circuits 60, in other words, for each one of the pixel electrodes 63.

FIG. 16 is a schematic cross-sectional view of the microcapsule 70 shown in FIG. 15. As shown in FIG. 16, the microcapsule 70 contains a dispersion medium 71, a plurality of white particles 72, and a plurality of black particles 73 inside a coating 71. The microcapsule 70 is formed in a spherical shape with a diameter of about 50 μm, for example.

The coating 71 functions as an outer shell of the microcapsule 70, and is formed from light transmissive polymeric resin, such as, acrylic resin including polymethyl methacrylate, polyethyl methacrylate or the like, urea resin, gum arabic, or the like.

The dispersion medium 72 is a medium in which the white particles 73 and the black particles 74 are dispersed in the microcapsule 70, in other words, in the coating 71. Examples of the dispersion medium 72 are water; alcohol solvents, such as, methanol, ethanol, isopropanol, butanol, octanol, and methylcellulose; esters, such as, ethyl acetate and butyl acetate; ketones, such as, acetone, methyl ethyl ketone, and methyl isobutyl ketone; aliphatic hydrocarbons, such as, pentane, hexane, and octane; alicyclic hydrocarbons, such as, cyclohexane and methylcyclohexane; aromatic hydrocarbons such as benzenes having a long chain alkyl group, such as, benzene, toluene, xylene, hexylbenzene, hebutylbenzene, octylbenzen, nonylbenzene, decylbenzene, undecylbenzene, dodecylbenzene, tridecylbenzene, and tetradecylbenzene; halogenated hydrocarbon, such as, methylene chloride, chloroform, carbon tetrachloride, 1,2-dichloroethane; carboxylic acid; and other oils, which may be used alone or in combination. The dispersion medium 72 may contain a surface-active agent.

The white particles 73 are particles, high polymer or colloid made of white pigments, such as, titanium dioxide, flowers of zinc (zinc oxide), or antimony trioxide, and are negatively charged, for example.

The black particles 74 are particles, high polymer or colloid made of black pigments, such as, aniline black or carbon black, and are positively charged, for example. Therefore the white particles 73 and the black particles 74 can move in the dispersion medium 72 due to an electric field generated due to the potential difference between the pixel electrodes 63 and the common electrode 64.

These pigments may be mixed with a charge control agent made of particles of an electrolyte, a surface-active agent, metallic soap, resin, rubber, oil, varnish, or a compound, a dispersion agent such as a titanium coupling agent, an aluminum coupling agent, or a silane coupling agent, a lubricant, or a stabilizing agent as necessary.

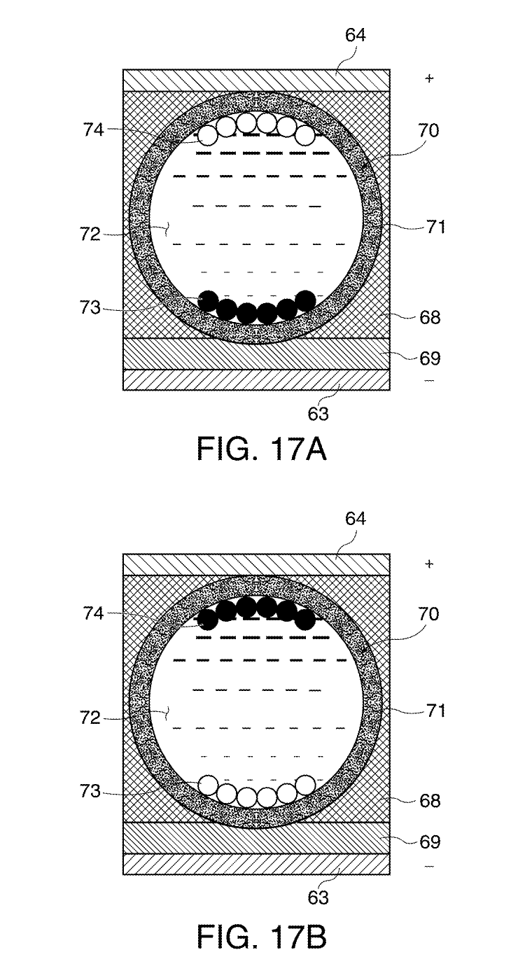

FIGS. 17A and 17B are schematic cross-sectional views for describing an operation of the microcapsules shown in FIG. 15 and FIG. 16. As shown in FIG. 17A, when voltage is applied between the pixel electrodes 63 and the common electrode 64 so that the potential of the common electrode 64 becomes relatively high, the positively charged black particles 74 are attracted toward the pixel electrodes 63 in the microcapsule 70 by Coulomb force, and the negatively charged white particles 73 are attracted toward the common electrode 64 in the microcapsule 70 by Coulomb force. As a result, the white particles 73 gather to the common electrode 22, that is, to the display surface side in the microcapsule 70, so that the white color can be displayed on the display surface of the display section 20.

In contrast, as shown in FIG. 17B, when voltage is applied between the pixel electrodes 63 and the common electrode 64 so that the potential of the pixel electrodes 63 becomes relatively high, the negatively charged white particles 73 are attracted toward the pixel electrodes 63 by Coulomb force, and the positively charged black particles 73 are attracted toward the common electrode 64 in the microcapsule 70 by Coulomb force. As a result, the black particles 74 gather to the display surface side in the microcapsule 70, so that the black color can be displayed on the display surface of the display section 20.

Red, green, blue, etc. can also be displayed by replacing the pigments used for the white particles 73 and the black particles 74 with pigments, for example, red, green, and blue.

As the electrophoretic display device 1 in accordance with the present embodiment is equipped with the DC-DC converter 56 in accordance with the invention described above, its power consumption can be reduced and, for example, power duration of a battery used for the device can be extended.

Electronic Apparatus

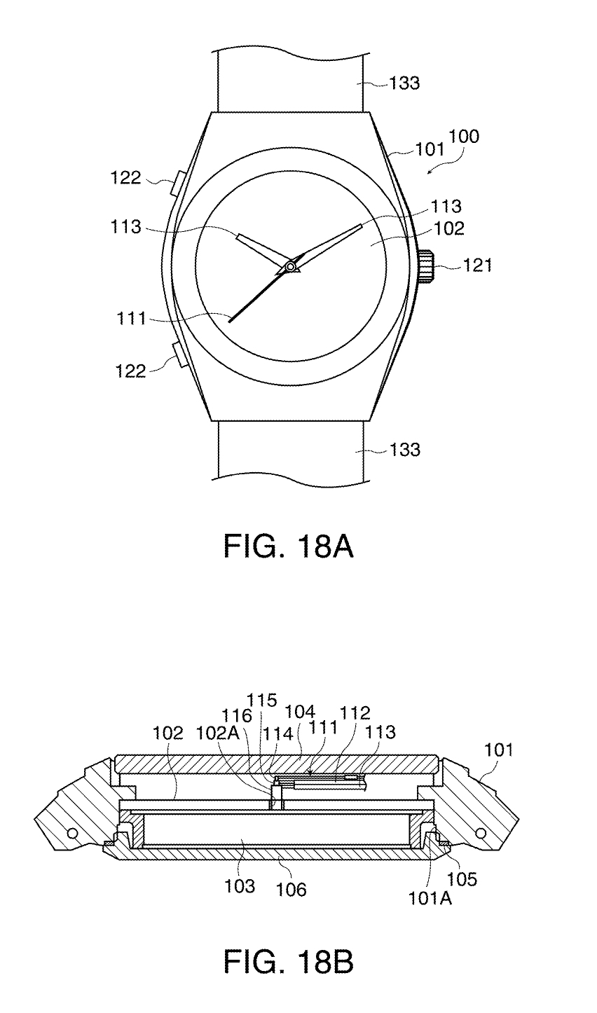

Next, referring to FIGS. 18 through 20, electronic apparatuses in accordance with embodiments of the invention will be described.

FIGS. 18A and 18B are views showing a wristwatch 100 equipped with the electrophoretic display device in accordance with the embodiment of the invention. FIG. 18A is a front view of the wristwatch 100. The wristwatch 100 includes a watch case 101, and a pair of bands 133 connected to the watch case 101.

In the front side of the watch case 101, an electrophoretic display device 102 in accordance with the embodiment described above, a second hand 111, a minute hand 112, and an hour hand 113 are disposed. In addition, on the side of the watch case 101, a winder 131 as an operator, and one or a plurality of operation buttons 132 is disposed.

As shown in the side cross-sectional view of FIG. 18B, a housing section 101A is provided within the watch case 101. The electrophoretic display device 1 and the movement 103 are contained in the housing section 101A. A transparent cover 104 made of glass or resin is provided on one side (the front surface side of the watch) of the housing section 101A. A back cover 106 is screwed into the other side (the back side of the watch) of the housing section 101A with a gasket 105 disposed there between. The watch case 101 is hermetically sealed by the transparent cover 104 and the back cover 106.

The movement 103 includes a hand movement mechanism (not shown) coupled to analog hands composed of the second hand 111, the minute hand 112 and the hour hand 113. The hand movement mechanism rotationally drives the second hand 111, the minute hand 112 and the hour hand 113 thereby functioning as a time display section to display the set time.

The electrophoretic display device 102 is disposed on the front face side of the movement 103 to constitute a display section of the wristwatch 100. A through-hole 102A that penetrates from the front to the back of the electrophoretic display device 102 is formed in the center of the electrophoretic display device 102. Shafts of a second wheel 114, a center wheel 115, and an hour wheel 116 of the hand movement mechanism of the movement 103 are inserted in the through-hole 102A. The second hand 111, the minute hand 112, and the hour hand 113 are attached to the ends of the respective shafts. In the present embodiment, the electrophoretic display device 102 has a circular display surface, but may have a display surface in, for example, a regular octagonal shape, a hexadecagonal shape or the like, without any particular limitation to the embodiment.

Electrophoretic display devices in accordance with the invention are also applicable to electronic apparatuses other than a watch.

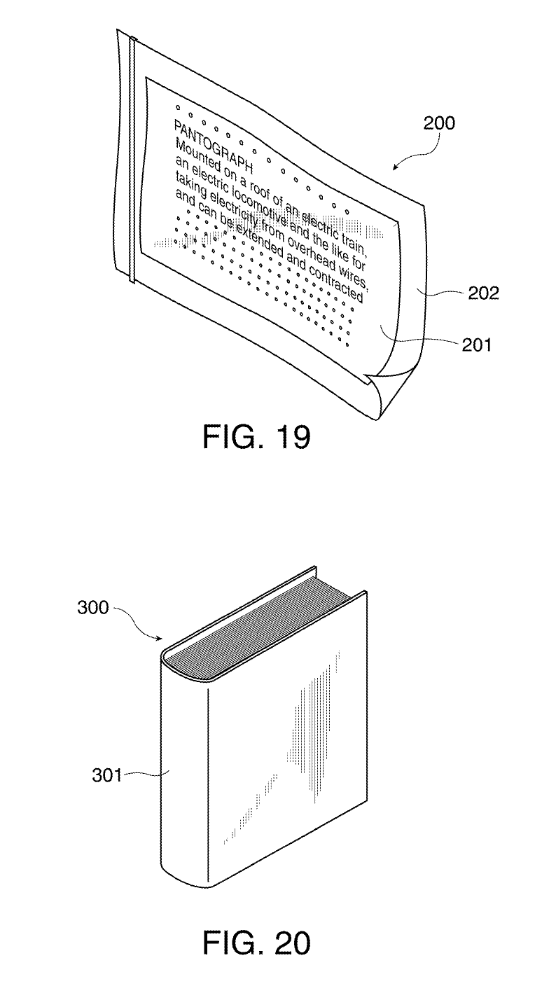

FIG. 19 is a perspective view showing an electronic paper 200 equipped with an electrophoretic display device in accordance with the invention. As shown in FIG. 19, the electronic paper 200 includes the electrophoretic display device in accordance with an embodiment of the invention as a display section 201. The electronic paper 200 is flexible and includes a sheet body 202 composed of a rewritable sheet with texture and flexibility similar to those of existing paper.

FIG. 20 is a perspective view showing an electronic notebook 300 equipped with an electrophoretic display device in accordance with an embodiment of the invention. The electronic notebook 300 is constituted such that multiple sheets of electronic paper 200 shown in FIG. 19 are bundled and placed between covers 301. The covers 301 may be equipped with, for example, a display data input unit (not shown) for inputting display data transmitted from, for example, an external apparatus. Accordingly, display contents can be changed or updated in accordance with the display data while the multiple sheets of electronic paper are bundled together.

The wristwatch 100, the electronic paper 200, and the electronic notebook 300 in accordance with the present embodiment are equipped with the electrophoretic display devices in accordance with the embodiment of the invention described above. As a result, the power consumption of these devices can be reduced, and various kinds of electronic apparatuses that require, for example, less battery replacement can be realized.

The structure of the invention is not limited to the embodiments described above and can be suitably modified without departing from the subject matter of the invention.

The entire disclosure of Japanese Patent Application No. 2010-107006, filed May 7, 2010 is expressly incorporated by reference herein.

What is claimed is:

1. A DC-DC converter comprising:
a body circuit that performs a first operation of outputting an input voltage inputted from one end to another end based on a control signal, and a second operation of boosting the input voltage and outputting the input voltage boosted through the other end; and
a control circuit that outputs the control signal to the body circuit, based on an external load connected to the other end of the body circuit.

2. A DC-DC converter according to claim 1, wherein the control signal is a pulse signal, and the control circuit sets a duty ratio of the pulse signal.

3. A DC-DC converter according to claim 1, wherein the body circuit includes unit circuits each having a capacitor and connected in series between the one end and the other end of the body circuit, and
the unit circuits connect the capacitors in parallel with respect to the input voltage in the first operation, and connects the capacitors in series with respect to the input voltage in the second operation.

4. A DC-DC converter according to claim 3, wherein the control circuit sets the duty ratio based on a time duration in which a charge stored in each of the capacitors reaches a predetermined amount.

5. An electrophoretic display device comprising the DC-DC converter recited in claim 1.

6. An electronic apparatus comprising the DC-DC converter recited in claim 5.
